(19) United States
(12) Patent Application Publication
(10) Pub. No.: US 2008/0215353 A1
(43) Pub. Date: Sep. 4, 2008

(54) Method of Frozen Donor Egg Banking

(76) Inventors: James W. Akin, Lexington, KY (US); Jeffrey Boldt, Carmel, IN (US); Diana Thomas, Phoenix, AZ (US)

Correspondence Address: MERCHANT & GOULD PC, P.O. BOX 2903, MINNEAPOLIS, MN, 55402-0903, US

(21) Appl. No.: 12/038,556

(22) Filed: Feb. 27, 2008

Related U.S. Application Data
(63) Continuation of application No. 11/513,214, filed on Aug. 31, 2006.

(51) Int. Cl. G06Q 50/00

(52) U.S. Cl. 705/1

(57) ABSTRACT

A method is provided for a frozen egg bank comprising a) retrieving egg cells from an egg donor; b) cryopreserving said eggs in a cryopreservation solution; c) quarantining said eggs; and d) testing the egg donor for an infectious agent following a quarantine period of time. Optionally the method may also include testing the egg donor for genetic disorders, stimulating follicular development of the egg donor, and releasing the eggs for sale following step (d).

### RELATED APPLICATIONS

This application claims the benefit of U.S. provisional application Ser. No. 60/584,883, filed Jul. 2, 2004, under 35U.S.C. §119(e).

### FIELD OF THE INVENTION

This invention relates to a business method of a frozen donor egg bank.

### BACKGROUND OF THE INVENTION

Until recently, there have not been reliable methods to freeze oocytes for later implantation. Instead, women wanting to undergo donor oocyte in vitro fertilization had to use fresh oocytes from donors. The fresh oocytes carry the risk of infectious diseases. Fresh oocytes also require the recipient to be synchronized with the donor and to be in close geographic proximity. Fresh donor oocytes cycles cost between $20,000 and $25,000.

Overall success rates with respect to survival of oocytes post-thaw and pregnancy rates have been very low, discouraging routine application of oocyte cryopreservation (Gook and Edgar, 1999; Paynter, 2000; Coticchio et al., 2001). In addition to low survival rates, studies have shown that oocyte cooling and/or freezing can cause significant disruption of the oocyte's meiotic spindle and other subcellular structures as well as have adverse effects on the zona pellucida, possibly due to premature cortical granule release (Al-Hasani et al., 1987; Sathananthan et al., 1987; 1988; Pickering et al., 1990; Van Blerkom and Davis, 1994).

There is an unmet need for egg banks akin to the success of sperm banks in the area of in vitro fertilization (IVF). With the success of reliable cryopreservation of eggs, a method of a frozen egg bank has been developed to meet this need in IVF.

### SUMMARY OF THE INVENTION

The present invention includes methods for a frozen donor egg bank. The present method can employ: a) retrieving eggs from a donor; b) cryopreserving said eggs; c) quarantining said eggs; and d) testing the egg donor for an infectious agent following a quarantine period of time. The present method can also employ releasing the eggs for sale following step (d) if the egg donor is negative for infectious diseases following the quarantine period. The present method can include an intake process in which the prospective egg donor undergoes a personal history, a medical and reproductive history, a physical examination, a psychological assessment, or combinations thereof. The present method can also include stimulating follicular development before retrieving the eggs.

In an embodiment, the present method can cryopreserve donated eggs in cryoprotective medium. In a further embodiment, the present method can include quarantining donated eggs for at least six months. Following six months, the egg donor can be re-tested for HIV and other infectious diseases.

In an embodiment, the prospective egg donor can undergo a physical examination including a pelvic examination and laboratory testing. Said laboratory testing can include testing for genetic disorders and infectious diseases.

### BRIEF DESCRIPTION OF THE FIGURES

FIG. 1 and FIG. 2 show the overall summary of the frozen donor egg bank business method procedure. FIG. 2 is a continuation of FIG. 1.

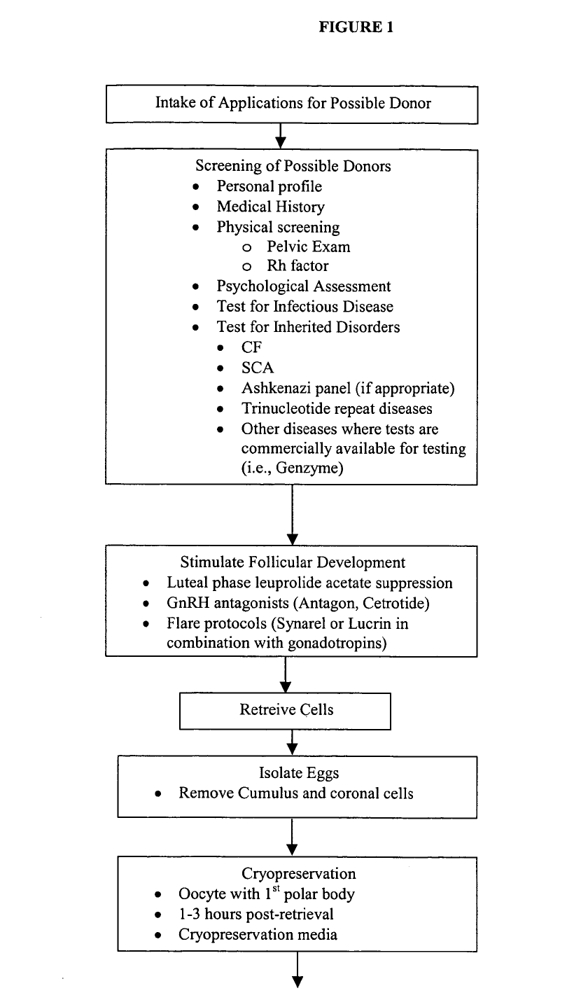

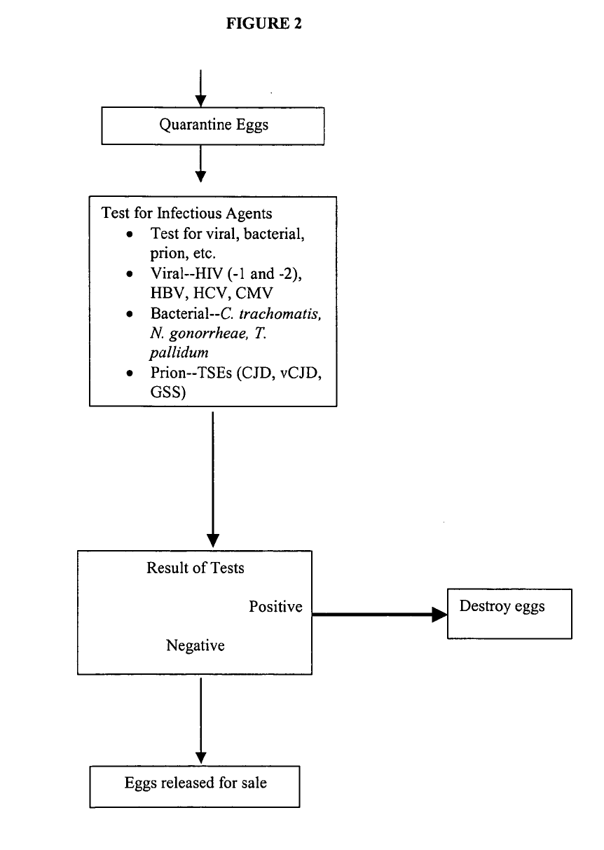

### DETAILED DESCRIPTION

### Definitions

The term “cryopreservation” refers to the maintenance of tissue, organ, or cell viability at extremely low temperatures, e.g., storage in liquid nitrogen.

The terms “egg” or “oocyte” or “ovum” refer to female sexual cells or gametes.

The term “quarantine” refers to detention and isolation for a period of time. Quarantining eggs allows subsequent testing of the egg donor for infectious disease. For instance, eggs can be quarantined for at least 6 months so the egg donor can be tested for HW and other infectious diseases. The passage of six months allows for a reliable HIV test to be performed to determine the egg donor's HIV status at the time of donation.

### Intake

The first step of the method is the intake of applications for possible egg donors. Upon intake, a possible donor can be screened for compatibility with egg donation. The prospective donor would have to answer questionnaires regarding a personal profile and a medical and reproductive history. The egg donor should have attained the age of majority, and is preferably between the ages of 21 and 34. Optionally, the egg donor can have a psychological assessment performed.

The egg donor can also have a physical screening performed. A general physical examination can be performed, including a pelvic examination and laboratory tests. Laboratory tests can include evaluating the egg donor for the presence of infectious diseases or agents. Laboratory tests may include, but are not limited to, tests to detect viral pathogens such as human immunodeficiency virus (HIV)-1, HIV-2, hepatitis B, hepatitis C, and cytomegalovirus. Laboratory tests may also include tests to detect bacterial pathogens such as Chlamydia trachomatis, Neisseria gonorrheae, and Treponema pallidum. Laboratory tests may include tests to detect a prion agent that causes a transmissible spongiform encephalopathy such as Creutzfeldt-Jakob Disease (CJD), variant CJD (vCJD), new variant CJD (nvCJD), and Gerstmann-Straussler-Sheinker (GSS) disease. A positive test for an infectious agent would preclude the prospective donor from proceeding and making an egg donation.

Laboratory tests would also include a genetic screening. The prospective donor should not have any major genetic abnormalities. According to the guidelines for egg donation (2004, Fertil. Steril. 82: S13-S23), an egg donor should not have any major Mendelian disorders, whether autosomal dominant or sex-linked. Prospective donors who are autosomal recessive do not necessarily have to be excluded if the recipient's partner is not heterozygous. In one aspect, all prospective egg donors should be screened for cystic fibrosis. Depending on a donor's background, a particularly suited genetic panel screen would be appropriate. For instance, someone of Ashkenzi Jewish heritage should be screened for Bloom syndrome, Canavan Disease, Familial Dysautonomia, Fanconi Anemia, Gaucher Disease, Mucolipidosis Type IV, Niemann-Pick Disease, Tay-Sachs Disease, or combinations thereof. Other genetic testing includes, but is not limited to, the detection of trinucleotide repeat diseases, such as Huntington's Disease, Fragile X syndrome, Friederich's Ataxia, or combinations thereof. Other genetic disorders can be tested wherein the tests are commercially available (e.g., Genyzme Genetics, Westborough, MA).

### Stimulating Follicles and Oocyte Retrieval

Patients can be stimulated using several protocols including luteal phase leuprolide acetate suppression, flare protocols, or GnRH antagonist protocols. Patients are generally given 10 000 IU hCG when there are at least two follicles of >18 mm diameter. Oocyte retrievals are done by transvaginal ultrasound 36 h (34-36 hours) after hCG. Oocytes are identified in the follicular aspirate by pouring the follicular fluid into an appropriate container and examining the aspirate under a microscope. Identified oocytes are then placed into an appropriate culture medium and prepared for the freezing process. Oocytes are either stretched on the bottom of a Petri dish and scanned for the presence of a first polar body, or the bulk of the cumulus cell mass is removed with 22 G needles followed by exposure to hyaluronidase (e.g., 80 IU/ml Type III; Sigma, USA) for about 30 seconds and aspiration through narrow bore micropipettes to complete cumulus and corona cell removal. Oocytes with a confirmed first polar body are then selected for cryopreservation. Immature (metaphase I or germinal vesicle) stage oocytes are not frozen. Presently, only mature oocytes recovered on the day of retrieval are frozen. Freezing is routinely initiated within 1-3 hours post-retrieval. Immature eggs are frozen in the future either directly or after in vitro maturation. For freezing, oocytes are placed into a cryoprotective medium that contains chemicals that protect the egg against damage during the freezing/thawing process. Chemicals used for cryopreservation include, but are not limited to, propanediol, dimethly sulfoxide, glycerol, and ethylene glycol. Alternatively, the cryoprotective chemicals are dissolved in culture media with or without normal concentrations of sodium to help protect against freezing damage.

### Cryopreservation

Two overall types of freezing techniques for eggs are provided as follows. In the first aspect, referred to as a slow freezing or controlled rate freezing method, eggs are placed into cryoprotective medium in a suitable container (either a freezing vial or freezing straw), and cooled slowly from about 20° C.-about 37° C. to about −5° C.-about −8° C. The container is then touched with a cold forceps or other device to induce seeding, which begins ice formation within the container. After about 5-15 minutes at the seeding temperature, the containers is slowly cooled to about −30 to about −40 degrees centrigrade, and the container is then plunged into liquid nitrogen and stored in a liquid nitrogen tank until thawing is desired. In a second aspect, vitrification involves placing eggs into relatively high concentrations of cryoprotectants, placing the eggs into a suitable container, and immediately plunging the container into liquid nitrogen.

Two specific examples of the slow freezing protocols are as follows. The first is a standard 1,2-propanediol (PrOH)-sucrose freezing method (Gook et al., 1993). Oocytes have their cumulus and corona cells removed as described above, are incubated for 10 min at room temperature in PBS-20% synthetic serum substitute (SSS; Irvine Scientific) containing 1.5 mol/L PrOH (Sigma), and then are transferred to 1.5 mol/L PROH containing 0.1 mol/l sucrose (cell culture grade; Sigma). Oocytes are frozen in Nunc vials containing 0.55 mL of PrOH-sucrose using the following freezing ramps: room temperature to about −7.0° C. at about −1.0° C. per min, hold at about −7.0° C. for about 5 minutes, seed; hold for an additional approximately 10 minutes at about −7.0° C.; cool at about −0.3° C. to about −35° C.; and then plunge into liquid nitrogen. All freezing runs are performed with a Planar Kryo 10 controlled rate freezer (TS Scientific, USA).

A second slow freezing protocol employs the use of Sodium (Na)-depleted PBS as the base medium for the cryopreservation solution, and is used for the cycles reported. The following recipe is used to prepare Na-depleted (—Na) medium (all chemicals were cell culture grade from Sigma): choline chloride 137 mmol/L, KCl 2.6 mmol/L, NaH₂PO₄ 8.0 mmol/L, KHPO₄ 1.4 mmol/L. The medium is best referred to as Na-depleted because of the NaH₂PO₄ salt. The pH is about 7.4. The cryopreservation solution comprises Na-depleted medium with 20% SSS, and supplemented with 1.5 mol/L PROH and 0.2 mol/L sucrose. Before freezing, cumulus and corona cells are removed, and the oocytes are then transferred into about 1-2 ml of cryopreservative solution and kept at room temperature (about 22 to about 24° C.) for approximately 20 min. The oocytes shrink rapidly upon exposure to the freezing solution and appear slightly shrunken at the end of a 20 min equilibration period. After the 20 min equilibration, oocytes are transferred into Nunc vials containing 0.5 ml of the same cryopreservative solution, and placed into the freezing chamber. The freezing ramps are as follows: room temperature to about −6.0° C. at about −2.0° C./min; hold for about 5 minutes; seed; hold an additional approximately 10 min at about −6.0° C.; cool at about −0.3° C. to about −33° C., and plunge into liquid nitrogen.

An embodiment of cryopreservation includes vitrification freezing. In vitrification freezing, eggs are obtained and placed in a solution containing a relatively low concentraton of cryoprotectant, e.g., 1.5 M propanediol. After exposure to this solution for 10 minutes, the eggs are then placed into a solution containing a very high concentration of cryoprotectant (e.g., 5.5M ethylene glycol/1.0M sucrose) such that there is no ice that forms within the cell during freezing. After an about 20 to an about 30 second exposure to the high concentration of cryoprotectant the eggs are then loaded into an appropriate container (such as electron microscopy grids, hemi-straws, and/or cryoloops), and the container is immediately plunged into liquid nitrogen for storage until use.

### Quarantine and Further Testing

Following retrieval and cryopreservation, the eggs are maintained in cryopreservation from 1 day to 12 months, or 3 to 9 months, or 4 to 8 months, or about 6 months. During this time of quarantine, the egg donor is tested or re-tested for infectious diseases. Many tests for infectious agents detect circulating antibodies. If an infection occurs recent to egg donation, the antibodies will not be detectable at that point in time. However, detectable titers can be found months after infection. For HIV, a majority of people have detectable amounts of circulating antibodies approximately 3 months post-infection. However, six months post-exposure is the benchmark to assess for circulating antibodies to HIV. Thus, an embodiment of the method is a minimum quarantine of six months to be assured that the egg donor was not infected with HIV at the time of donation. Once the egg donor has been tested or re-tested following a quarantine period, the eggs can be released for sale following negative test results for infectious agents.

### Thawing

For frozen donor egg thawing and subsequent embryo transfer cycles, endometrial preparation involves the use of estrogen pills or patches such as is used with frozen embryo transfer cycles. Alternatively, a natural cycle can be used instead. Once the endometrium reaches a thickness of greater than or equal to about 9 mm, i.m. progesterone supplementation is started, and oocytes are thawed on the first day of progesterone administration. For any freezing protocol, vials are thawed by immersion in a water bath until all ice crystals have disappeared. The contents of the freezing vial are examined under a microscope and oocytes identified. For the freezing protocols described above, oocytes are transferred to a dish containing cryoprotectants, and the eggs are transferred through altering concentrations of cryoprotectants to allow the eggs to rehydrate in an appropriate fashion. Oocytes are observed after about 30 to 60 minutes to confirm viability, and intracytoplasmic sperm injection (ICSI) is performed about 2 to 4 hours after thawing.

Oocytes are examined about 16 to 20 hours post-ICSI, and the presence of two pronuclei are taken as evidence of normal fertilization. Embryo transfers are done about 3 to 5 days after thawing under ultrasound guidance. Embryos are examined daily, and all embryos showing progression of cleavage are considered for transfer. Embryos arrested prior to the day of transfer (defined as failure of cell division over a 24 h period) are not then considered for transfer. Embryos are graded for cell number and quality prior to transfer. Different fertility clinics may use different embryo scoring or grading scales. One non-limiting example of a grading scale is as follows: grade 4: even sized/shape blastomeres with no fragmentation; grade 3: <10% fragmentation and/or slightly irregular-shaped blastomeres; grade 2: 10-50% fragmentation and/or irregular size/shape blastomeres; and grade 1: >50% fragmentation with irregular size/shape blastomeres; Chemical assisted hatching with acid Tyrode's or mechanical hatching may be performed on all transferred embryos. Patients are discharged about 30 minutes after completion of the transfer, and pregnancy tests can be carried out 12 days after embryo transfer. Patients with positive serum hCG levels are followed for up to 12 weeks before referral for obstetric care.

### Other Applications of the Method

There are several reasons why oocyte cryopreservation may be desired. Couples undergoing assisted reproductive treatment who do not wish to have embryos frozen for ethical or religious reasons could benefit from preserving excess oocytes for use in subsequent cycles. Additionally, oocyte freezing could be useful in countries that do not allow embryo freezing to be conducted. Women with conditions that would result in oophorectomy or irreversible ovarian failure (such as with chemotherapy, radiation therapy, or certain genetic disorders) are potential candidates for either oocyte freezing. Women may prefer to freeze oocytes to provide an option for having children later in life, such as women fearing the ‘biological clock’ issue.

### EXAMPLES

### Example 1

### Egg Cell Donation and Banking

A prospective egg donor answers an advertisement seeking egg donors for renumeration. Upon intake of her application, she is screened for suitability. She answers a personal profile. For instance, she is 5′7″, 145 pounds, Caucasian, and a non-smoker. She has no previous reproductive history and no history of major illnesses or surgeries. This prospective egg donor has a physical examination, including a pelvic exam. In addition, blood is drawn to determine Rh factor and to test for infectious diseases such as HIV-1, HIV-2, HBV, HCV, and CMV, and genetic disorders. The prospective donor will be tested for cystic fibrosis, trinucleotide repeat diseases, and hemophilia. Without any Ashkenazi Jewish heritage, the prospective egg donor will not be screened for the Ashkenazi panel. After the physical examination does not reveal any medical issues and the tests for infectious diseases and genetic disorders are negative, then the prospective egg donor meets at least once with a psychologist for a psychological assessment. After passing the screening procedures, the prospective egg donor signed an Egg Donor Agreement.

The Donor has her follicles stimulated with a luteal GnRH agonist/gonadotropin protocol. Eggs are retrieved at the appropriate time. Eggs with a confirmed first polar body are selected and cryopreserved in sodium (Na) depleted medium. The cryopreserved eggs are quarantined until after the Donor is retested for HIV 6 months after egg retrieval. The Donor is still negative for HIV after six and a half months following donation. Since the donor is negative for infectious diseases and genetic disorders, the Donor's eggs are release for sale. The Donor remains anonymous to the recipient. The Donor's eggs are bought by a couple, wherein the wife is infertile. The donated eggs are thawed and then fertilized by intracytoplasmic sperm injection 3 hours after thawing. The eggs display the presence of two pronuclei and are observed over 3 days. Finally, the embryo is implanted into the wife's uterus three days after thawing. Pregnancy follows.

### Example 2

### Recipient Couple

A patient contacted her physician's office seeking assistance with her infertility. After evaluating the patient, it was recommended that the patient's best chance of conception involved the use of donor oocyte therapy. Two options were provided to the patient; one involving the use of fresh eggs from a donor synchronized with the recipient's cycle, and the second involving the use of frozen donor eggs. The patient and her partner decided to pursue the use of frozen donor eggs. The patient then contacted CryoEggs International to examine the physical characteristics and medical history of donors who have had eggs frozen, and selected a specific donor. The patient was then monitored to determine when the lining of her uterus (endometrium) was of an appropriate thickness. Once the endometrium reached an appropriate thickness, the patient began progesterone supplementation and the eggs were thawed on the day progesterone supplementation began. The patient had purchased 7 eggs, and these were thawed with 5 of 7 eggs surviving the thawing. At 4 hours after thawing each egg was injected with a single sperm cell, and the eggs were then evaluated for fertilization at 15 hours after insemination. There were 4 eggs fertilized, and these were then placed into culture and examined 24 hours later to determine if the fertilized eggs were developing into embryos. Three of the fertilized eggs showed evidence of cleavage. The following morning (about 65 hours after egg thawing) the three embryos were again evaluated, and each had assisted hatching performed. The three embryos were then transferred to the recipient, and a pregnancy test performed 12 days post-transfer. A positive pregnancy test resulted from this procedure.

What is claimed is:

1. A business method of a frozen donor egg bank comprising:
a) retrieving egg cells from an egg donor;
b) cryopreserving eggs in a cryopreservation solution;
c) quarantining eggs; and
d) testing egg donor for an infectious agent following said quarantine.

2. The method of claim 1, wherein the quarantine is at least 6 months.

3. The method of claim 1, wherein the infectious agent comprises human immunodeficiency virus (HIV)-1, HIV-2, hepatitis B virus, hepatitis C virus, cytomegalovirus, Chlamydia trachomatis, Neisseria gonorrheae, and Treponema pallidum.

4. The method of claim 1 further comprising stimulating follicular development prior to retrieving cells.

5. The method of claim 4, wherein follicles are stimulated by one or more of the following selected from the group consisting of luteal phase leuprolide acetate suppression, gonadotropin-releasing hormone (GnRH) antagonist, Synarel, Lucrin in combination with gonadotropins, Gonal F, follicle stimulating hormone (FSH), and luteinizing hormone (LH).

6. The method of claim 5, wherein the GnRH antagonist is Antagon or Cetrotide.

7. The method of claim 1, wherein the cryopreserving oocytes occurs within 1 to 3 hours post-retrieval.

8. The method of claim 1, wherein the cryopreserving comprises oocytes having a first polar body.

9. The method of claim 1, further comprising screening oocyte donors prior to step (a).

10. The method of claim 9, wherein screening oocyte donors comprises at least one of a personal profile, a medical history, a physical screening, and a psychological assessment.

11. The method of claim 10, wherein said physical screening comprises at least one of a pelvic exam, a determination of Rh factor, testing for infectious agents, and testing for inherited disorders.

12. The method of claim 11, wherein said tested inherited disorders comprise cystic fibrosis, sickle cell anemia, an Ashkenazi panel, trinucleotide repeat diseases, genomic imprinting diseases, and hemophilia.

13. The method of claim 1, further comprising releasing oocytes for sale following step (d).

14. The method of claim 1, wherein said cryopreservation solution comprises a sodium depleted medium at about pH 6.0 to about 8.0.

15. The method of claim 14, wherein said pH is about 7.0 to about 7.6.

16. The method of claim 15, wherein said pH is about 7.4.

17. The method of claim 1, wherein said sodium depleted medium comprises sodium depleted phosphate buffered saline, sucrose, and propanediol.

18. The method of claim 17, wherein said sodium depleted medium comprises about 20% synthetic serum substitute, about 1.5 mol/L propanediol, and about 0.2 mol/L sucrose.
